(19) United States
(12) Patent Application Publication
(10) Pub. No.: US 2009/0092706 A1
(43) Pub. Date: Apr. 9, 2009

(54) Food Product and Process for Preparing it

(76) Inventors: Hendrikus Theodorus van der Hijden, Vlaardingen (NL); Nikolaos Mavroudis, Vlaardingen (NL); Henricus Petrus Peters, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/988,462

(22) PCT Filed: Jun. 13, 2006
(86) PCT No.: PCT/EP2006/005691

§ 371 Date: Jan. 8, 2008

(30) Foreign Application Priority Data
Jul. 8, 2005 (EP) 05076574.2

(51) Int. Cl. A23L 1/28

(52) U.S. Cl. 426/49; 426/61

(57) ABSTRACT

Starch containing food products having controlled energy release properties are provided, wherein at least 25% by weight of the starch is contained within intact plant cells.

### FIELD OF THE INVENTION

The invention relates to food products. More in particular, it relates to a starch containing food product having controlled or delayed energy release properties and to a process for preparing such product.

### BACKGROUND TO THE INVENTION

According to World Health Organisation recommendations, the optimal diet to maintain health comprises at least 55% total energy from a variety of carbohydrate sources. Cereals with high starch content provide the main source of carbohydrates world-wide. Many other food products comprise starch, such as bread, pasta, and potatoes.

Starch is a homopolymer of glucose. It consists of essentially linear amylose molecules and highly branched amylopectin molecules. Starch can be rapidly converted to glucose in the intestinal tract. The glucose then enters the blood stream and provides the body with energy. In humans, starch degradation is initiated by the action of alpha-amylase in the saliva. The digestion of the remaining starch molecules is continued by the actions of pancreatic alpha-amylases. In general, pancreatic amylase is more important for digestion because food generally does not remain in the mouth long enough to be digested thoroughly by salivary amylase. The major products of starch digestion by human alpha-amylase are di- and oligosaccharides. Final hydrolysis of these products is carried out by the oligosaccharide-degrading enzymes amyloglucosidase (glucan 1,4-alpha-glucosidase) and isomaltase (oligo 1,6 glucosidase) in the brush border.

However, there is increasing evidence that a high intake of food products leading to a high glycaemic (blood glucose) response has a deleterious effect on type-2 diabetes and cardiovascular disease. Diets leading to a low glycaemic response appear to be useful in the management of the metabolic syndrome and of hyperlipidaemia. Lowering of cholesterol levels has also been observed in healthy subjects and there are also indications of improvements in fibrinolytic activity.

Differences in the post-prandial glucose profile may also be of physiological significance for satiety and weight maintenance. Data regarding the satiating capacity in relation to glycaemic features are, however, not consistent.

Much less information is present regarding the potential impact of post-prandial glycaemic level on cognitive function and mental performance. There are some studies to support a relationship between glucose availability and changes in mood and/or mental function (‘energy’, ‘alertness’, ‘concentration’, ‘reduced irritability’, ‘reduced fatigue’, ‘vitality’). The optimal blood glucose curve has yet to be defined.

The concept of ‘energy’ is used widely in the food industry. However, most ‘energy’ claims are not scientifically substantiated and the underlying technology is mostly generic. Furthermore, the concept is very much restricted to cereals and biscuits. For other applications in which the water content is higher and heat is applied in the production process, this approach will not work. For example, when starch granules are heated in the presence of water, gelatinization occurs, which renders the starch molecules fully accessible to digestive enzymes, resulting in rapidly digestible starch. Depending on the process, part of the starch might also turn into indigestible starch without nutritional value.

It is therefore an object of the present invention to provide a starch containing food product having controlled energy release properties and which overcomes one or more of the above mentioned draw-backs. Surprisingly, it has now been found that the above-mentioned object can be achieved by the starch containing food product according to the invention, wherein at least 25%, preferably at least 40%, more preferably at least 60% by weight of the starch is contained within intact plant cells.

According to the invention, natural plant cell barriers (i.e. the plant cell wall) are used to delay the hydrolysis of starch inside the plant cells. In particular intact pea cells and banana cells showed, also after heating, excellent controlled energy release properties.

### SUMMARY OF THE INVENTION

According to a first aspect, the invention provides a starch containing food product having controlled energy release properties, wherein at least 25% by weight of the starch is contained within intact plant cells.

According to a second aspect, there is provided a process for preparing such a food product.

### DETAILED DESCRIPTION OF THE INVENTION

The invention relates to a starch containing food product. By the word “starch”, we mean any homopolymer of glucose, including naturally occurring conjugated forms of starch such as phosphorylated starch. Naturally occurring starches contain linear amylose molecules and highly branched amylopectin molecules.

The food product of the present invention has “controlled” energy release properties. There are now several ways to visualise and quantify the glycaemic effect of foods. The glycaemic index (GI) concept has been introduced to enable comparison of foods based on their glycaemic effect. It provides a standardised comparison for the 2 hour post-prandial glucose response of a carbohydrate with that of white bread or glucose.

Avoiding products that cause an immediate high blood sugar level will help to get a lower glucose response, but that can also be accomplished by “slow” carbohydrates. In that respect, one now speaks of rapidly available carbohydrates (RAC) or slowly available carbohydrates (SAC) or, specifically for starch and its digestibility, of rapidly digestible starch (RDS), slowly digestible starch (SDS), and resistant starch (RS). Rapidly digestible starch is starch that is quickly hydrolysed, which results in high blood glucose concentrations, which are maintained for only a short time. SDS is defined as starch that is likely to be completely digested in the small intestine but at a slower rate, resulting in lower blood glucose levels that are maintained for a longer time.

Resistant starch is the sum of starch and products of starch degradation that are not absorbed in the small intestine of healthy humans. RS therefore reaches the colon where it can be fermented by present micro-organisms and where it can play a role in the maintenance of human digestive health.

The determinants of post-prandial glucose excursions are numerous and include the amount and nature of the carbohydrates ingested, the rate of gastric emptying, the rates of intraluminal carbohydrate digestion and of intestinal glucose absorption, the entero-pancreatic hormonal response, and specific postabsorptive metabolic changes. Of these processes the rates of gastric emptying and digestion/absorption were the most important ones. The rate of digestion is the major determinant of glycaemia in the case of starchy foods. Differences in glycaemic responses to dietary starch are directly related to the rate of starch digestion.

As indicated above, slowly available glucose (SAG) is likely to be completely digested in the small intestine but at a slower rate, resulting in lower blood glucose levels that are maintained for a longer time. On the other hand, rapidly available glucose (RAG) is carbohydrate that is quickly hydrolysed, which results in high blood glucose concentrations, which are maintained for only a relatively short time.

Englyst et al. (Englyst K N, Englyst H N, Hudson G J, Cole T J, Cummings J H. Rapidly available glucose in foods: an in vitro measurement that reflects the glycaemic response. American Journal of Clinical Nutrition (1999) 69:448-54.) used an in vitro test that correlates significantly to the in vivo glucose curves. The in vitro measurement of RAG and SAG could predict the glycaemic response measured in human studies. Englyst et al. defined RAG in the in vitro situation by the amount of carbohydrate hydrolysed to glucose after 20 min (called G20). Also the amount hydrolysed was measured after 120 minutes (called G120). The amount hydrolysed during these 120 minutes was considered to be available for absorption in the small intestine. Anything hydrolysed after the 120 min was considered not available for absorption and considered resistant. The amount of carbohydrates hydrolysed between 20 and 120 min (i.e. G120-G20) was defined as SAG. In the ideal situation one would like to have a carbohydrate with a very low G20 and a very high G120, resulting in a high difference between G20 and G120. However, many efforts in industry to make certain products slowly digestible render them (partly) resistant. As such one wants to keep G120 as close as possible to the theoretical maximum (i.e. 100% of the total amount of theoretically available carbohydrate).

In the present invention, we define “controlled energy release” as the release of carbohydrates represented by an in vitro hydrolysis (curve), where G120-G20 is significantly higher than in a proper control that contains the same amount of available carbohydrate, while G120 is as high as possible, i.e. at least 50, 65, 80 or even 90% of the theoretical maximum.

By varying the relative amounts and by combining rapidly digestible carbohydrates (i.e. starch) and carbohydrates with the above-mentioned properties, the release properties of energy in a food product can be controlled.

According to the present invention, natural plant cell barriers (i.e. the plant cell wall) may be used to control the hydrolysis of starch inside the plant cells. In the following Table 1, some examples are given of plant cells that contain sufficient amounts of starch during some of their developmental phases, i.e. at least about 5% by weight, so that they may be used in the present invention.

TABLE 1

Roots/Tuber:
Cassava (Manihot esculenta)
Potatoes (Solanum tuberosum)
Parsnips (Pastinaca sativa)
Yam (Dioscorea spp)
Tannia (Xanthosoma sagittifolium)
SEEDS:
(a) grains
Corn (zea mays)
Durum wheat (triticum durum)
Hard white wheat (triticum aestivum)
Buckwheat (Fagopyrum esculentum Moench)
Oat (avena sativa)
Wild rice (Zizania spp.)
Brown rice (Oryza sativa L.)
(b) nuts
Brazil nuts (bertholletia excelsa)
Chinese chestnut (casteanea mollissima)
Cashew (anacardium occidentale)
Japanese chestnut (casteanea crenata)
Butternut (juglans cinerea)
Ginkgo nuts (ginkgo biloba)
Pistacio (pistacia vera)
Acorn (quercus spp)
Beechnut (fagus spp)
(c) legumes
Lima bean (phaseolus lunatus)
Black/kidney beans (phaseolus vulgaris)
pinto beans (phaseolus vulgaris)
white beans (phaseolus vulgaris)
yellow beans (phaseolus vulgaris)
broad beans (vibia faba)
winged beans (Psophocarpus tetragonolobus)
hyacinth beans (Dolichos purpureus)
chickpeas (Cicer arietinum)
yambean (Pachyrhizus spp.)
cowpeas (Vigna unguiculata)
cowpeas (Vigna unguiculata cylindrica)
lentils (lens culinaris)
yardlong bean (Vigna uniguiculata sesquipedalis)
mung bean (vigna radiata)
mungo bean (vigna mungo)
soybean (glycine max)
peas green (Pisum sativum)
Fruits:
banana (Musa paradisiaca)
plantains (musa X paradisiaca)
(unripe) dates (Phoenix dactylifera)
(unripe) durian (Durio zibethinus)
(unripe) mango (Mangifera indica)
(unripe) figs (Ficus carica)

Two types of cells were found to be of particular use in the present invention, namely pea cells and banana cells.

Intact plant cells or aggregates of intact plant cells may be prepared from complete plants or parts thereof by a process wherein the cell adhesion is reduced, such that the individual cells or small aggregates of cells are formed. Aggregates of plant cells are small lumps or clusters of plant cells, which may be from 200 μm up to 5 mm in diameter.

The process of preparing intact plant cells generally involves a soaking step or a homogenising step, a heating step and a sieving step, optionally followed by a spray-drying step. Suitable aqueous media for reducing the cell adhesion by pre-soaking include:
1. 0.1M, 0.5M and 1M EDTA solutions,
2. 0.04, 0.05, 0.08 and 0.2g NaHCO₃/g solutions
3. Water, Na₂CO₃ solutions
4. 0.05-0.5 M citrate
5. 0.50-0.5 M phosphate
   Other agents that could result in cell separation are suitable enzymes such as pectinase, pectate and pectin-lyase.

After soaking for a number of hours for instance overnight, the cells can separated by a mild heating at temperature of 50 to 75° C. for up to 90 minutes. Then, the plant material (cooled or warm) is sieved sequentially through a number of sieves with an aperture equal to or higher than:
1. 5 mm
2. 2 mm
3. 1 mm
4. 500 um
5. 250 um sieves

Depending on the need for separation of the cell at specific clusters or aggregates, a suitable subset of sieves can be used. Maximum cell separation can be obtained by using the lowest aperture sieve. A maximum degree of cell separation reduces the likelihood that intact plant cells are detected in the food product during consumption.

For the purpose of the present invention the intactness of the plant cells in a suspension can be quantified by two approaches:

(a) Using a haemocytometer: The heamocytometer can be used for quantifying the maximum number of single intact cells produced. A haemocytometer consists of a glass slide with a chamber for counting cells in a given volume. The chamber contains a ruled area and the counting was done visually with the aid of a light microscope. The single cell material was turned to a suspension by being diluted to 0.056 g material/ml. One drop from the cell suspension was added to the centre of the haemocytometer glass. The dispersion of the cells was kept homogenous by adding 1 to 4 mg/ml guar gum. The number of cells in each main square was counted. The number of cells per volume was calculated; knowing that the depth of haemocytometer glass is 1 mm and one main square of the haemocytometer corresponds to an area of 1 mm². A LEICA DMRB (Das Mikroskop Research Biologisch) light microscope with a JVC KY55 camera was used to obtain the images. Some typical values obtained for pea cells are shown in Table 2 below.

TABLE 2
Cell counts corresponding to each treatment condition. All were
sequentially sieved through 1 mm, 450 μm and 250 μm sieves.

| | | Cell count |
|---|---|---|
| Soaking conditions | Temperature-Time | (cells/mm³) |
| Overnight, 0.056 g | 50° C., 90 minute | 12 |
| NaHCO₃/ml soln | | |
| Overnight, 0.05 g | 60° C., 90 minute | 31 |
| NaHCO₃/ml soln | | |
| Overnight, 0.05 g | 70° C., 15 minute | 27 |
| NaHCO₃/ml soln | | |
| Overnight, 0.05 g | 70° C., 90 minute | 50 |
| NaHCO₃/ml soln | | |

(b) Wet sieving: Wet sieving could be used for obtaining an overview of the percentage of intact cells (either single or aggregates) vs. the percentage of broken cells and free starch. After the creation of intact cells (either single or aggregates) a given amount (say 50 g) is being suspended to a given amount of water. The suspension is passed through a series of sieves. The selection of the sieves with the lower apertures is made on the basis of the cell diameter of the commodity that was cell separated. For the case of the pea cells a series of sieves with apertures equal or lower of 5 mm, 2 mm, 500 μm, 250 μm, 200 μm and 100 μm were used. The sample retained on the sieves of 100 μm was collected and centrifuged at 3500 g for 3 minutes. The precipitate was collected and its weight was measured. The weight of the precipitate was expressed as percentage of the initial weight of the plant material.

The % starch contained in intact plant cells (either in single cells or aggregates) can be calculated using the following methods.

An amount of the plant material is collected and analysed for starch content (TS). An amount of plant material paste is mixed with water. The wet sieving is performed as described above in the wet sieving section and the fractions of intact cells (either single or aggregates) are collected and its starch content is analysed. This will provide the amount of intact cell starch (ICS) which will result in a delayed release of the glucose. The percentage of starch retained in intact cells is calculated on the basis of the measured values of ICS and TS.

The intact plant cells may be stored in an aqueous solution, but they are preferably spray-dried to obtain a dry powder. Such dry powders can be conveniently used in the preparation of complete, starch containing food products.

Some Examples of starch containing food products in accordance with the present invention (but not limiting to these) are: drinks/beverages, meal replacement products such as drinks, bars, powders, soups, dry soups/powdered soup concentrates, (fat) spreads, dressings, (whole) meals, desserts, sauces, sport drinks, fruit juices, snack foods, ready-to-eat and pre-packed meal products, ice creams and dried meal products. (Dry) soups are especially preferred.

The starch containing food products can be prepared by admixing the starch containing plant cells, in dry form or in the forms of an aqueous suspension, with the rest of the food product.

The starch containing food product may optionally further comprise conventional ingredients such as proteins, fats, salt, flavour components, colourants, emulsifiers, preservatives, acidifying agents and the like.

The invention can be further illustrated by means of the following non-limiting examples. In the drawings:

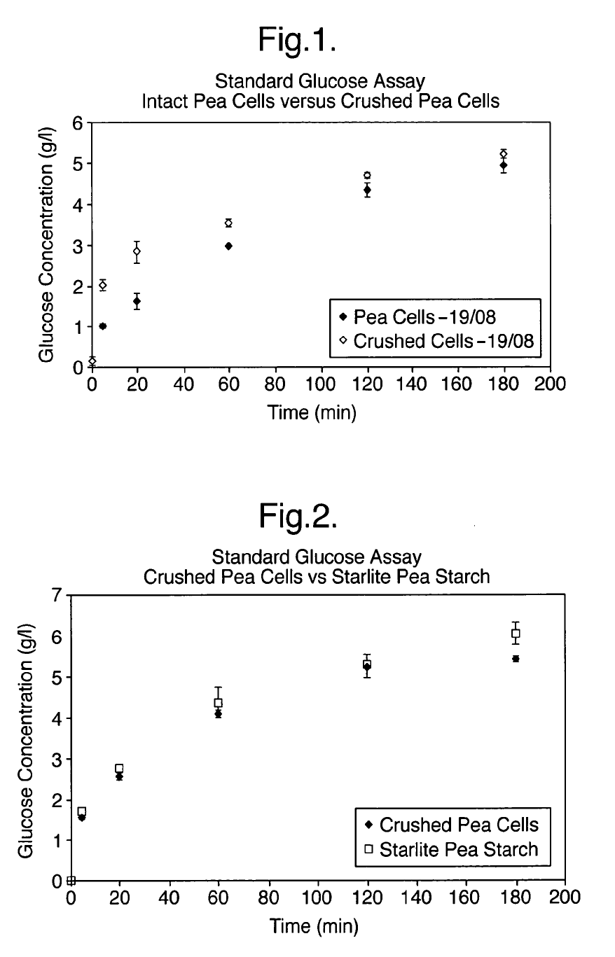

FIG. 1 shows a Glucose Release curve from pea cells and crushed pea cells upon standard glucose assay. Suspensions were subjected to pre-assay treatment at 100° C. for 40 minutes (Megazyme D-Glucose HK Assay Kit).

FIG. 2 shows a Glucose Release Curve from crushed pea cells and starlite pea starch which were used in equivalent total hydrolysable carbohydrate amount, upon the action of a standard glucose assay. Suspensions were subjected to pre-assay treatment at 100° C. for 40 minutes. (Enzytec HK Assay Kit)

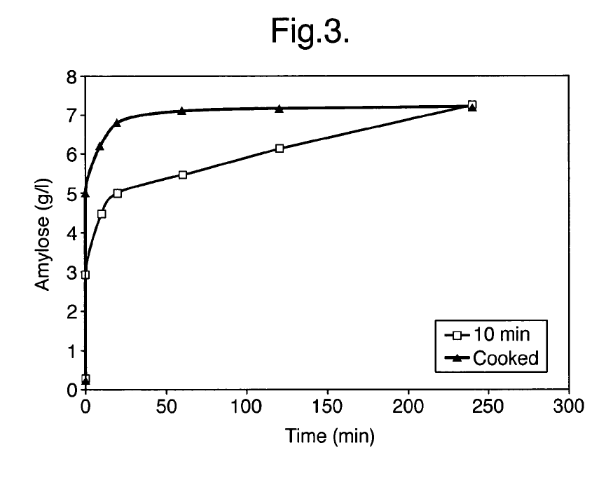

FIG. 3 shows Maltose concentration (g/L) based on the 540 nm absorption of the DNSA treated samples of Banana cells.

### Enzymatic Starch Hydrolysis

### Alpha-Amylase Based on Bernfeld

(Bernfeld, P., 1955, Amylases, α and β, Methods in Enzymology, Vol. 1, Academic Press, N.Y., 149-158). A suspension of 1% starch was made in 0.02 M phosphate buffer pH 6.9, containing 0.067 M NaCl. In some cases, suspensions were heated about 1 minute at 800 W in a microwave oven. A 1% solution of Biobake a-amylase was made in 0.9% NaCl. Starch samples were mixed one to one with enzyme solution and mixtures were incubated at 37° C. at +/− 100 r.p.m. in a shaking incubator (Innova 4080). Samples were taken at different time intervals and analysed for the degradation of starch by the colourimetric assay described below. Blanks were prepared with phosphate buffer and denatured enzyme solutions.

### Alpha Amylase or Pancreatin and Amyloglucosidase Based on Englyst

(Englyst, K. N., Englyst, H. N., Hudson, G. J., Cole, T. J., Cummings, J. H., 1999, Rapidly available glucose in foods: an in vitro measurement that reflects the glycaemic response, American journal of clinical nutrition 69, 448-454).

To 10 to 20 ml starch samples, ranging from 0.5 to 2% (w/v) starch, 2.5 or 5 ml enzyme solution was added. Starch samples were made in 0.1 M sodium acetate buffer of pH 5.2, containing 0.004 M CaCl₂ (Englyst et al., 1999). When starch was heated in order for gelatinisation to occur, starch suspensions were heated for 5-60 minutes at 100° C. in a water bath (Lauda), and cooled to room temperature afterwards.

The enzyme solutions used for the incubation of starch samples contained either:
1. 3375 units/ml α-amylase and 16 units/ml amyloglucosidase
2. 3375 units/ml pancreatin, and 16 units/ml amyloglucosidase

All enzyme solutions were made in water. When using pancreatin for the enzyme solutions, 18 gram pancreatin was dissolved in 120 ml water and suspended by stirring. After centrifugation for 15 minutes at 1,500 g, 90 ml of the supernatant was mixed with 10 ml water. To this solution, amyloglucosidase was added. Incubations were performed in a shaking incubator or in a shaking waterbath (Grant) at 37° C., at 100-160 r.p.m. Samples were taken after different time intervals, but always after 20 and 120 minutes of incubation.

Samples obtained from both incubation methods were analysed for the degradation of starch by a colourimetric assay measuring reducing end groups or by quantification of the glucose concentration.

### Acid Total Starch Hydrolysis

Starch was suspended in 0.5 ml water and hydrolysed under acid conditions (0.5 ml 2M HCl added) at 99° C. during 2 hours to obtain total starch hydrolysis. After cooling 0.5 ml 2M NaOH was added to neatralise the sample. The amount of hydrolysed starch was determined via quantification of glucose either by a colourimetric or enzymatic assay.

### Quantification of Hydrolysed Hydrolysed Starch

### (a) Colourimetric

Reducing end groups were measured with a method described by Bernfeld (1955). 10 g of 3,5-dinitrosalicylic acid (DNSA) was dissolved in 200 ml 2M NaCl and 500 ml H₂O. Stirring and heating the suspension up to 60° C. promoted dissolving. After that, 300 g Rochelle salt (sodium potassium tartrate tetrahydrate) was added and the solution was adjusted to 1,000 ml with H₂O. The DNSA solution was kept from light at room temperature. 500 μl of samples to be analysed was added to 500 μl DNSA solution and heated for about 5 minutes at 100° C. in a thermomixer (Eppendorf thermomixer comfort). After that, tubes containing the mixtures were cooled under running tap water or on ice. Solutions were diluted properly with H2O and the absorbances were measured at 540 nm (Shimadzu). Standard concentrations of maltose (ranging from 0-5 mg/ml) were prepared in 0.02 M phosphate buffer pH 6.9, containing 0.067 M NaCl. From the absorbances measured, maltose concentrations were calculated.

### (b) Enzymatic Glucose Assay

The glucose concentration of samples was measured using an enzymatic kit (Megazyme D-Glucose HK Assay Kit, available from Enzytec). The measurement was based on the following principle:

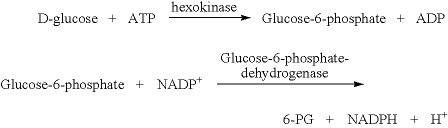

The reaction was performed in 3 ml plastic cuvettes. To 1 ml of triethanolamine (TEA) buffer of pH 7.6, containing approximately 80 mg NADP and 190 mg ATP, 100 il of sample or standard glucose solution was added, followed by 1.9 ml H₂O. To the blank solution, 2 ml H₂O was added. Solutions were mixed and after approximately 3 minutes the absorbance was measured at 340 nm against water. Then, 20 μl of a hexokinase/glucose-6-phosphate dehydrogenase suspension (200 U/100 U) in ammonium sulphate was added to the solutions and solutions were mixed. After 10-15 minutes the absorbance was measured again and measurements were repeated after 2 minutes to check if the reactions had stopped. The glucose concentration of the samples was calculated with the following formula:

c=(V×Mw×ΔA)/(ε×d×v×1000) [g glucose/l sample solution]

c=(3.020×180.16×ΔA)/(6.3×0.1×1000)=0.8636×ΔA[g glucose/l sample solution]

### EXAMPLE 1

### Pea Cells

Cells were isolated from dried marrow fat peas purchased from the local supermarket. The intercellular interactions were weakened by overnight soaking in 0.2 g/ml NaHCO₃, followed by a heat treatment at 70° C. during 90 minutes. The cells were then physically separated by 3 subsequent sieving steps (1 mm, 0.5 mm and 0.25 mm respectively). After the sieving steps the pea cells were spray-dried (LabPlant, SDS20) and stored in powder form to be used in the assessment of the barrier properties of the cells. To assess the effects of cell barrier properties, starch hydrolysis assays were applied to both the intact cell powder and the physically crushed cell powder. The crushed cell powder was prepared from the dried pea cells after sieving through a 0.075 mm sieve. The material that passed through the sieve was crushed with mortar and pestle into crushed pea powder. Before the enzyme assay both the intact and the crushed cell powder were heat treated at 100° C. for 40 minutes. The intact and crushed cells were subjected to the hydrolysis assay with pancreatin and amylogucosidase (based on Englyst) and glucose content was quantified with the enzymatic glucose assay. The amount of the samples of the intact and crushed cells in the hydrolysis assay was based on an equal amount of starch as determined with the total starch hydrolysis assay. The results are given in FIG. 1. It is clear that intact pea cells give a significantly slower starch hydrolysis compared to the crushed cells, which shows that controlled energy release can be obtained by means of intact pea cells.

The hydrolysis pattern of crushed cells was also compared to that of a commercially available pea starch. FIG. 2 shows that the hydrolysis patterns are nearly identical, indicating that the intactness of cell is essential for controlled energy release. Furthermore, a comparison between crushed pea cells and cooked maize starch resulted in nearly identical hydrolysis curves in the starch hydrolysis assay, indicating that the slower rate of the hydrolysis of the intact plant cells was due to the cell integrity rather than to other constituents of the pea cell.

### EXAMPLE 2

### Hydrolysis of Banana Starch

Banana cells were isolated in a similar manner. To this end unripe banana (plantain) fruit was peeled and cut into small slices. Slices were soaked overnight in a citric acid buffer containing 1% ascorbic acid and 0.185% (w/w) EDTA and blended in a kitchen blender. The resulting slurry was sieved through 0.5 and 0.25 mm sieves and cheesecloth. The filtrate was stored chilled overnight and the cells were dried in an oven. The cells were suspended 0.2M phosphate and heated at 97° C. during 10 minutes. After cooling the rate of hydrolysis of the banana starch was determined with the Bernfeld assay. For comparison, a same amount (as determined by the total starch analysis assay) of cooked maize starch was also hydrolysed in the Bernfeld assay.

After a heat treatment, a slow hydrolysis of the banana starch as compared to the maize starch was obtained, indicating that controlled energy release can be obtained by means of intact banana cells. The results are shown in FIG. 3.

1. Starch containing food product having controlled energy release properties, wherein at least 25% by weight of the starch is contained within intact plant cells.

2. Food product according to claim 1, wherein at least 40% by weight of the starch is contained within intact plant cells.

3. Food product according to claim 1, wherein at least 60% by weight of the starch is contained within intact plant cells.

4. Food product according to claim 1, wherein the intact plant cells occur in the form of aggregates of plant cells having a diameter of less than 5 mm.

5. Food product according to claim 4, wherein the aggregates of plant cells having a diameter of less than 1 mm, preferably less than 0.5 mm.

6. Food product according to claim 1, wherein at most 80% of the starch is present in a gelatinised form.

7. Food product according to claim 1, wherein the plant cells are selected from the group consisting of roots/tubers, seeds (grains, nuts or legumes) or fruits.

8. Food product according to claim 1, wherein the plant cells are pea cells or banana cells.

9. Food product according to claim 1, having a high moisture content.

10. Food product according to claim 9, in the form of a liquid product selected from the group consisting of sauces, soups and drinks.

11. Process for the preparation of starch containing intact plant cells from complete plants or parts thereof, comprising a soaking step or a homogenising step, a heating step and a sieving step, optionally followed by a spray-drying step.

12. Process for the preparation of a starch containing food product according to claim 1, comprising the step of adding intact starch containing plant cells to a food product.

1. Starch containing food product having controlled energy release properties, wherein at least 25% by weight of the starch is contained within intact plant cells.

2. Food product according to claim 1, wherein at least 40% by weight of the starch is contained within intact plant cells.

3. Food product according to claim 1, wherein at least 60% by weight of the starch is contained within intact plant cells.

4. Food product according to any one of the preceding claims, wherein the intact plant cells occur in the form of aggregates of plant cells having a diameter of less than 5 mm.

5. Food product according to claim 4, wherein the aggregates of plant cells having a diameter of less than 1 mm, preferably less than 0.5 mm.

6. Food product according to any one of the preceding claims, wherein at most 80% of the starch is present in a gelatinised form.

7. Food product according to any one of the preceding claims, wherein the plant cells are selected from the group consisting of roots/tubers, seeds (grains, nuts or legumes) or fruits.

8. Food product according to any one of the preceding claims, wherein the plant cells are pea cells or banana cells.

9. Food product according to any one of the preceding claims, having a high moisture content.

10. Food product according to claim 9, in the form of a liquid product selected from the group consisting of sauces, soups and drinks.

11. Process for the preparation of starch containing intact plant cells from complete plants or parts thereof, comprising a soaking step or a homogenising step, a heating step and a sieving step, optionally followed by a spray-drying step.

12. Process for the preparation of a starch containing food product according to claims 1-10, comprising the step of adding intact starch containing plant cells to a food product.
